(19) United States
(12) Patent Application Publication
(10) Pub. No.: US 2004/0018473 A1
(43) Pub. Date: Jan. 29, 2004

(54) Set of elements for assembling structures

(75) Inventor: Edoardo Pio Tusacciu, Calangianus (IT)

Correspondence Address: YOUNG & THOMPSON, 745 SOUTH 23RD STREET 2ND FLOOR, ARLINGTON, VA, 22202

(73) Assignee: PLAST WOOD S. R. L., CALANGIANUS (IT)

(21) Appl. No.: 10/602,608

(22) Filed: Jun. 25, 2003

(30) Foreign Application Priority Data
Jul. 15, 2002 (IT) RM2002U000133

(51) Int. Cl. G09B 25/00

(52) U.S. Cl. 434/73

(57) ABSTRACT

The invention relates to a set of elements for assembling complex structures, the set comprising a plurality of first magnetic bar elements, having a first length, a plurality of ferromagnetic elements, and a plurality of second magnetic bar elements, having a second length. Said two lengths and the dimension of said ferromagnetic elements are such to allow the assembling of complex structures, e.g. classic crystallographic structures.

The present invention relates to a set of elements for assembling structures.

More specifically, the invention concerns a set of the above kind employing magnetic elements having different and suitable dimensions and ferromagnetic elements, preferably ferromagnetic spheres.

Particularly, by the present set it is possible to assemble tridimensional structures of every kind, even of the crystallographic kind, both for playing and educational purposes, but also shapes for reproducing objects.

It is already known the existence of systems to be able to realise tridimensional complex shapes or structures by elements that can be coupled magnetically. Particularly, as described in the GB patent No. 726328, magnetic elements exist not only with the simple NS (North-South) polarity, but also with combined polarities NSN or SNS, having different shapes, or others that can be coupled in an original way to be able to create different structures.

Systems are known, comprised of ferromagnetic elements, or bars, and metallic spheres, providing inside, embedded, a magnet, thus allowing the realisation of tridimensional structures, being it possible to represent also some crystallographic shapes.

It is further known a system comprised of a set of means including bar like elements, all having the same length, said elements being each one comprised of two magnets, one on each of the two ends, separated by a ferromagnetic interspace, and of ferromagnetic spheres. Said system allows to realise complex tridimensional structures.

The problem that the present invention aims to solve concerns the possibility of building a bigger variety of tridimensional and crystallographic structures employing the minimum number of elements.

Furthermore, having at disposal magnetic elements, such bar like elements, and ferromagnetic elements, such spheres, it is an object of the present invention that of allowing to realise assemblies more stable under the structural point of view, making it possible, in this way, to assemble bigger and more complex assemblies.

It is therefore object of the present invention a set of elements for assembling complex structures, the set comprising a plurality of first magnetic bar elements, having a first length, a plurality of ferromagnetic elements, and a plurality of second magnetic bar elements, having a second length.

Particularly, said first and second lengths can be determined in such a way that, using only two bar elements, it is possible to realise many of the classic bi- and tri-dimensional structures.

Preferably, according to the invention, the ferromagnetic elements have symmetrical tridimensional shape.

Still more preferably, according to the invention, the ferromagnetic elements have a spherical shape.

Furthermore, according to the invention, said second length of the second bar elements can be chosen corresponding to the length of the diagonal of the square comprised of four first bar elements as sides, coupled each other in correspondence of the corners of the square by four electromagnetic elements.

Still according to the invention, said second length of the second bar elements can be chosen corresponding to a integral fraction of the length of the diagonal of the square comprised of four first bar elements as sides, coupled each other in correspondence of the corners of the square by four electromagnetic elements.

Advantageously, according to the invention, said integral fraction can be half (½) of the diagonal.

Still according to the invention, said integral fraction can be one third (⅓) of the diagonal.

Furthermore, according to the invention, said integral fraction can be one fourth (¼) of the diagonal.

Preferably, according to the invention, said second length of the second bar elements is the half (½) of the diagonal of the square comprised of four first bar elements as sides, coupled each other in correspondence of the corners of the square by four electromagnetic elements, minus one of the main dimensions of said ferromagnetic element.

The main dimension of a ferromagnetic element can be comprised, for example in a parallelepiped element, by one of the distances between opposite faces of the geometrical figure.

Advantageously,. according to the invention, said main dimension is the diameter of the sphere.

Still according to the invention, said ferromagnetic elements can be used both as vertex of the complex figures and as coupling elements for said second bar elements provided along said diagonals.

Furthermore, according to the invention, said ferromagnetic elements can be used both as vertex of the complex figures and as coupling elements of at least two of said second bar elements, in such a way to couple with the same second bar elements at the centre of complex figures.

Preferably, according to the invention, main dimension of said ferromagnetic elements corresponds to about (√3-√2) times the length of the corner used to create a complex figure, said corner length being the distance between the centres of the two ferromagnetic elements used.

Furthermore, according to the invention, the above set of elements can provide second ferromagnetic elements having dimensions different with respect to those of the first ferromagnetic elements.

Still according to the invention, said second ferromagnetic elements are used as coupling elements for said second bar elements provided along the diagonals of the figures.

Furthermore, according to the invention, said second ferromagnetic elements can be used as coupling elements provided in such a way to couple at the centre of complex figures.

According to the invention, said first bar elements can have an octagonal cross-section.

According to the invention, said second bar elements can have an octagonal cross-section.

Still according to the invention, said first bar elements and/or said second bar elements can have an outer cover, said cover does not cover the basis of the bar element.

Furthermore, according to the invention, said first bar elements and/or said second bar elements can have an outer cover that can partially or completely include the basis, said cover being preferably comprised of plastic material.

Preferably, according to the invention, the ferromagnetic elements are comprised of steel.

The present invention will be now described, for illustrative but not limitative purposes, according to its preferred embodiments, with particular reference to the figures of the enclosed drawings, wherein:

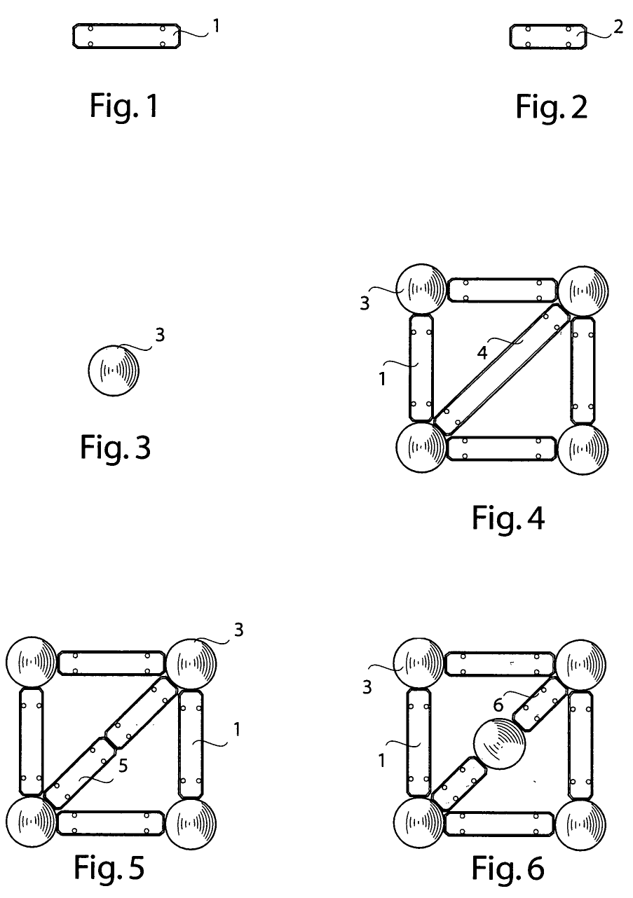

FIG. 1 shows a first magnetic bar of a set according to the invention;

FIG. 2 shows a second magnetic bar of a set according to the invention having a length minor than the first bar element;

FIG. 3 shows a spherical ferromagnetic material element of a set according to the invention;

FIG. 4 shows the realisation of a square having a diagonal realised by a single module;

FIG. 5 shows the realisation of a square having a diagonal realised by to modules;

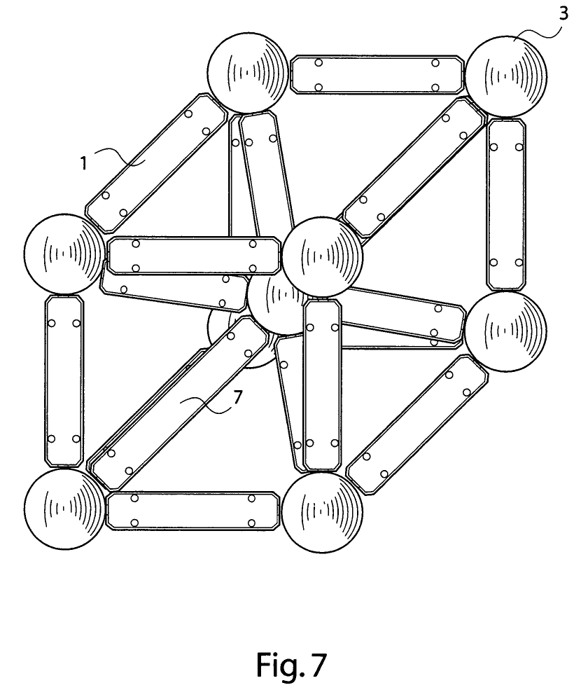

FIG. 6 shows the realisation of a square having a diagonal realised by two modules and a coupling spherical block; and

FIG. 7 shows the realisation of a centred face cube.

Making reference to FIG. 1, it can be seen a magnetic bar 1 having a determined length. Said bar can be eventually coated by plastic material, such as polypropylene, to protect the metallic material. Further, in case under evaluation, the bar has an octagonal cross-section.

In FIG. 2 it can be observed a magnetic bar 2 equivalent to the magnetic bar 1, but characterised in that it has a different length, that can be suitably calculated in order to obtain determined geometric figures.

FIG. 3 shows a ferromagnetic coupling element 3, in this case of spherical shape. Material to realise said element can be for example steel.

Making reference to FIG. 4 it can be observed the coupling of four magnetic modules 1 coupled in such a way to realise a square, putting four spherical coupling elements 3 into the corners. Two opposed vertexes are coupled by a further magnetic module 4, thus realising the diagonal of the same square. Assuming the dimension of the module 1 equal to I, ray of the coupling sphere 2 equal to r and the length of module 4 equal to a, the following relationship is obtained to realise the described figure:

a=√2(I+2r)−2r

FIG. 5 shows the same square described in FIG. 1, comprised of four modules 1 and four spherical coupling elements 3, having the diagonal comprised of two elements 5 long the half of a single element 4, thus creating a diagonal with two modules.

FIG. 6 shows the same square shown in FIGS. 4 and 5, comprised of four modules 1 and of four spherical coupling elements 3, having a diagonal realised by two modules 6 coupled by a central spherical coupling element 3. In this way it is possible to realise more complex shapes. Relationship between the dimension of the module 6, indicated as b, and with respect to dimension of module 1 and to the coupling element 3 (using the same symbols indicated for FIG. 3):

b=√/2×(I+2r)−2r

FIG. 7 shows a centred face cube, the twelve corners of which are realised by modules 1, coupled by eight spherical coupling elements 3. Each corner of the cube is coupled with a further coupling element 3 provided at the centre of the same cube by the same module 7. Relationship between length / of the corner created by modules 1, dimension r of the ray of the sphere of the coupling element 3 and the dimension, indicated by c, of the element 7 coupling the vertex at the centre of the cube, is:

c=(I+2r)/2×(√3)−2r

if we want to consider the absolute dimensions of an ideal cube, it is sufficient to subtract to the length a and c of the bars, the amount 2r, taking into account the finished dimension of the coupling element. In this way, ratio between the distance of a corner and the centre of the cube, with respect to the same cube, is equal to √3/2. Instead, if we want to know the dimension of a single sphere to be used for all the vertexes, and to leave the dimensions consequently determined, then the latter will have a diameter equal to √−√2 times the length of the absolute corner of the ideal cube corresponding to the evaluated structure.

It is possible to realise the centred face cube also using only modules 1, but using spherical coupling elements 3 with a different diameter.

By the present innovation, it is possible to realise assembly to play or to study, to represent crystallographic structures with a minimum number of elements, making the same structures more resistant and obtaining also economic advantages with respect to the number of elements to be used to realise complex elements.

The present invention has been described for illustrative but not limitative purposes, according to its preferred embodiments, but it is to be understood that modifications and/or changes can be introduced by those skilled in the art without departing from the relevant scope as defined in the enclosed claims.

1. Set of elements for assembling complex structures, characterised in that it comprises a plurality of first magnetic bar elements, having a first length, a plurality of ferromagnetic elements, and a plurality of second magnetic bar elements, having a second length.

2. Set of elements according to claim 1, characterised in that the ferromagnetic elements have a symmetric tridimensional shape.

3. Set of elements according to claim 1 or 2, characterised in that the ferromagnetic elements have a spherical shape.

4. Set of elements according to one of the preceding claims, characterised in that said second length of the second bar elements corresponds to the length of the diagonal of the square comprised of four first bar elements as sides, coupled each other in correspondence of the corners of the square by four electromagnetic elements.

5. Set of elements according to one of the preceding claims 1-3, characterised in that said second length of the second bar elements corresponds to a integral fraction of the length of the diagonal of the square comprised of four first bar elements as sides, coupled each other in correspondence of the corners of the square by four electromagnetic elements.

6. Set of elements according to claim 5, characterised in that said integral fraction is half (½) of the diagonal.

7. Set of elements according to claim 5, characterised in that said integral fraction is one third (⅓) of the diagonal.

8. Set of elements according to claim 5, characterised in that said integral fraction is one fourth (¼) of the diagonal.

9. Set of elements according to one of the preceding claims 1-3, characterised in that said second length of the second bar elements is the half (½) of the diagonal of the square comprised of four first bar elements as sides, coupled each other in correspondence of the corners of the square by four electromagnetic elements, minus one of the main dimensions of said ferromagnetic element.

10. Set of elements according claim 9 when depending on claim 3, characterised in that said main dimension is the diameter of the sphere.

11. Set of elements according to claim 9 or 10, characterised in that said ferromagnetic elements are used both as vertex of the complex figures and as coupling elements for said second bar elements provided along said diagonals.

12. Set of elements according to one of the preceding claims 9-11, characterised in that said ferromagnetic elements are used both as vertex of the complex figures and as coupling elements of at least two of said second bar elements, in such a way to couple with the same second bar elements at the centre of complex figures.

13. Set of elements according to claim 12, characterised in that the main dimension of said ferromagnetic elements corresponds to about (√3−√2) times the length of the corner used to create a complex figure, said corner length being the distance between the centres of the two ferromagnetic elements used.

14. Set of elements according to one of the preceding claims, characterised in that it provides second ferromagnetic elements having dimensions different with respect to those of the first ferromagnetic elements.

15. Set of elements according to claim 14, characterised in that said second ferromagnetic elements are used as coupling elements for said second bar elements provided along the diagonals of the figures.

16. Set of elements according to claim 14 or 15, characterised in that said second ferromagnetic elements are used as coupling elements provided in such a way to couple at the centre of complex figures.

17. Set of elements according to one of the preceding claims, characterised in that said first bar elements have an octagonal cross-section.

18. Set of elements according to one of the preceding claims, characterised in that said second bar elements have an octagonal cross-section.

19. Set of elements according to one of the preceding claims, characterised in that said first bar elements and/or said second bar elements have an outer cover, said cover does not cover the basis of the bar element.

20. Set of elements according to one of the preceding claims 1-18, characterised in that said first bar elements and/or said second bar elements can have an outer cover that can partially or completely include the basis, said cover being preferably comprised of plastic material.

21. Set of elements according to claim 19 or 20, characterised in that, the ferromagnetic elements are comprised of steel.

22. Set of elements according to each one of the preceding claims, substantially as illustrated and described.
